(19) United States
(12) Patent Application Publication
(10) Pub. No.: US 2026/0009291 A1
(43) Pub. Date: Jan. 8, 2026

(54) ACTUATOR FOR DRIVING A SCREEN

(71) Applicant: SOMFY ACTIVITES SA, CLUSES (FR)

(72) Inventors: Alexandre MEYLAN, Cluses (FR); Xavier COLET, Cluses (FR); Etienne DELASALLE, Cluses (FR); Didier JEGOU, Cluses (FR); Laurent GUILLOT, Cluses (FR)

(21) Appl. No.: 18/992,497

(22) PCT Filed: Jul. 7, 2023
(86) PCT No.: PCT/EP2023/068934

§ 371 Date: Jan. 8, 2025

(30) Foreign Application Priority Data
Jul. 11, 2022 (FR) FR2207110
Mar. 20, 2023 (FR) FR2302576

(51) Int. Cl. E06B 9/72; E06B 9/24; E06B 9/68

(52) U.S. Cl. CPC E06B 9/72; E06B 9/24; E06B 2009/6809

(57) ABSTRACT

The invention relates to an actuator for driving a sun protection or blocking screen between a plurality of positions, the actuator comprising an electric motor (4), a reduction gear (6), at least one battery (8) powering the geared motor, a circuit (12) for controlling the geared motor, a charging connector (16) designed to allow the at least one battery (8) to be connected to a power supply device, the actuator also comprising a casing (2) having a longitudinal axis (X) for housing the motor (4), the reduction gear (6), the battery (8) and the control circuit (12), the charging connector (16) being a standard connector, the actuator being intended to co-operate with a power supply device comprising a standard connector corresponding to the standard connector of the actuator. The control circuit (12) has means for transmitting, to the power supply device, a request for a power supply profile comprising at least a

[symbol]

### TECHNICAL FIELD AND PRIOR ART

The present invention relates to an actuator for driving a sun protection or privacy screen, such as a shutter, between a plurality of positions.

An example of an actuator for driving a sun protection or privacy screen between a plurality of positions, is described in document EP3896247.

Such actuators for shutters or roller blinds include a torque support and a casing wherein are housed an electric motor, a reduction gear, one or a plurality of supply batteries and at least in part, a control circuit. The casing has a cylindrical shape of revolution. The torque support and the casing are mechanically connected to each other. The torque support or actuator head comprises support elements for mounting the actuator on a frame, i.e. on a fixed structure of a building wherein same is installed.

The actuator is intended to be inserted at least partially into a winding tube on which the sun protection or privacy screen is intended to be wound.

The reduction gear is extended by an output shaft extending outside the casing and rotating relative to the casing for rotating the winding tube, e.g. through a connecting accessory between the output shaft and the winding tube.

The control circuit comprises one or a plurality of electronic circuits. In particular, it manages the power to be supplied to the motor and the power supply to the batteries. The actuator includes a charging connector, in particular at the torque support or at the end of a charging cable exiting at a lateral or radial face of the torque support. The charging connector connects the battery or the batteries to an external device for charging the battery or the batteries.

Generally, the power supply device includes a connector of a first type and the actuator includes a compatible charging connector. Such type of connector is satisfactory, however the ergonomics of connection can be improved. Furthermore, it is desirable to be able to improve the charging process in order to increase the lifetime of the battery or of the batteries.

### OUTLINE OF THE INVENTION

It is thus a goal of the present invention to provide an actuator for driving a sun protection or privacy screen between a plurality of positions, the management of the power supply of which is made more ergonomic and more efficient.

The goals stated hereinabove is achieved by an actuator for driving a sun protection or privacy screen between a plurality of positions, the actuator comprising an electric motor, a reduction gear, one or a plurality of batteries, a control circuit and an electrical connection for the battery or the batteries in preparation for the charging of the battery or of the batteries, said electrical connection including a charging connector. The actuator further comprises a torque support and a casing, housing the electric motor, the reduction gear, the battery or the batteries and at least part of the control circuit. The charging connector is a standard connector, advantageously such as the universal serial bus or USB (Universal Serial Bus) connector, very advantageously such as USB-C®, version 3.0 or higher. The actuator is intended to cooperate with a power supply device including a standard connector corresponding to the standard connector of the actuator. According to the invention, the control circuit comprises means of transmitting a request for a power supply profile comprising at least a fixed voltage and a maximum current.

In an advantageous example, the actuator and the charging connector thereof are configured to support a PD (Power Delivery) technology, whereby a fixed voltage at the input of the actuator with a maximum current is suitable for the needs of the actuator according to the power supply profile selected by the actuator and transmitted by the actuator to the power supply device. For this purpose, the actuator, in particular the control circuit, comprises e.g. a controller between the charging connector and the battery or the batteries. The controller is configured to charge the battery or the batteries according to the voltage and current level required by the battery or the batteries from the voltage and current at the input of the charging connector. A quick charging of the battery or the batteries is thereby possible.

Alternatively or in addition to the PD technology, the actuator and the charging connector thereof are configured to support a programmable power supply (PPS) technology wherein the voltage and current are dynamically adapted according to the determined state of the battery or of the batteries. The actuator is suitable for evaluating the supply parameters of the battery or of the batteries and to transmit information about the evaluated supply parameters through the standard charging connector. The exchange of information allows the voltage and current delivered by the power supply to the control circuit to be dynamically adjusted to adequately charge the battery or the batteries. Charging is then carried out by knowing the level of charge of the battery or of the batteries. Such exchanges of data take place e.g. regularly e.g. every 10 seconds or every minute or every 10 minutes. The actuator thereby comprises means for evaluating power supply parameters of the at least one battery and means for transmitting information relating to the evaluated power supply parameters via the standard charging connector. Thereby, the required power supply profile is regularly re-evaluated and renegotiated in order to adapt to the needs of the battery or of the batteries in order to optimize the charge thereof, thereby leading to an efficient charging.

By optimizing the charging, the lifetime of the battery or of the batteries is increased. In a particularly advantageous example, the standard connector is a USB-C® (also denoted by USB Type-C®). Such connector has the advantage of being symmetrical so the connection thereof to a power supply device having a corresponding connector is very easy. Furthermore, the actuator supports PD (power delivery) technology, compatible with versions 3.0 and higher of the USB-C® charging connector, which leads to a fast charging and high supply voltage.

Communication between the power supply and the actuator allows the actuator to detect which type of power supply it is connected to, either a mains-connected power supply or a photovoltaic panel. The power supply device is e.g. a device connected directly to the mains or a photovoltaic panel placed close to the actuator, e.g. on the casing of the blocking element, and provided with a connector for the connection to the charging connector of the actuator.

The charging procedure is then adapted to the type of power supply device.

The knowledge of the type of power supply device by the actuator also makes it possible to adapt the information feedback provided to the user, e.g. to indicate the state of the actuator, e.g. if the actuator is being charged or is charged.

In one example of embodiment, the actuator, the charging connector thereof, and the power supply device are configured to support a power supply technology according to at least a first power supply profile and a second power supply profile during a charging phase, the first power supply profile and the second power supply profile being distinct by at least one power supply profile parameter value, such that the power supply device supplies voltage and current according to the first power supply profile and the second power supply profile. One or both of the actuator and the power supply device further include means configured to transmit an information signal to the user informing the user at least that the charging of the actuator is taking place according to at least one of the first and second power supply profiles. The user is then informed not only that the actuator is being charged but also under what conditions the actuator is being charged. In the example of embodiment where the charging takes place using power delivery technology, the user is informed and knows that the charging takes place in an optimized manner.

The means for transmitting the information signal include e.g. a Zener diode interposed between the power supply source and a means configured to transmit a signal, e.g. a light-emitting diode, said Zener diode becoming conductive for a supply voltage of the first or of the second power supply profile.

A subject matter of the present invention is then an actuator for driving a sun protection or privacy screen between a plurality of positions, the actuator comprising an electric motor, a reduction gear, at least one battery supplying the electric motor, a control circuit, a charging connector configured for the connection of the actuator to a device for supplying power the at least one battery, said actuator also including a torque support and a casing with a longitudinal axis housing the electric motor, the reduction gear, the battery and at least one part of the control circuit, the charging connector being a standard connector, said actuator being intended to cooperate with a power supply device including a standard connector corresponding to a standard connector of the actuator. The control circuit includes means for transmitting, to the power supply device, a request for a power supply profile comprising at least a fixed voltage and a maximum current.

In an advantageous example, the control circuit comprises means for evaluating power supply parameters of the at least one battery and means for transmitting information relating to the power supply parameters evaluated through the standard charging connector.

For example, the charging connector has a plurality of pins, a part of the pins being used to transmit the power supply profile required by the actuator.

The control circuit may comprise a controller arranged between the charging connector and the at least one battery, the controller being configured to charge the at least one battery based on the voltage and current at the input of the charging connector.

Preferably, the control circuit is configured to manage the power supply to the at least one battery in a first mode when the voltage and current at the input of the charging connector correspond to the power supply profile required by the actuator, and in a second mode when the voltage and current at the input of the charging connector differ from the power supply profile required by the actuator. For example, the control circuit comprises a user interface and is configured to send at least one information through the interface to a user that differs depending on the power supply device connected to the actuator.

In an advantageous example, the control circuit comprises a first circuit board supporting a control circuit of the electric motor and a second circuit board supporting the charging connector, the second board being arranged perpendicularly to the longitudinal axis at a longitudinal end of the casing, the charging connector being oriented radially with respect to the longitudinal axis.

Advantageously, the second board includes a first circular part and a second part arranged radially so as to form a protrusion with respect to the outer contour of the first part, and the charging connector is fastened to the second board so as to extend predominantly at the protrusion.

The charging connector very advantageously comprises a plane of symmetry, and the second circuit board includes a cutout wherein the charging connector is mounted, said plane of symmetry being substantially parallel, more particularly substantially coincident, with a plane wherein the second board extends.

Preferably, the charging connector complies with the USB-C® standard and is configured to transmit information using a PD (Power Delivery) technology and, if appropriate, a PPS (Programmable Power Supply) technology.

Another subject matter of the present invention is an assembly including at least one actuator according to the invention and a power supply device for the at least one battery of the actuator. The power supply device may include at least one standard connector compatible with the standard charging connector of the actuator and, when the power supply device is connected to the actuator and upon reception of a request for a power supply profile comprising at least a fixed voltage and a maximum current, the power supply profile is selected by the actuator according to the capacities provided by the charging device, the power supply device being configured to supply the voltage and current corresponding to the profile.

The charging connector and the power supply device advantageously comprise magnetic interlocking means.

Another subject matter of the present application is a method of supplying power to an actuator for driving a sun protection or privacy screen between a plurality of positions, the actuator including an electric motor, a reduction gear, at least one battery powering the electric motor, a control circuit, a charging connector configured to enable the actuator to be connected to a device for supplying power to the at least one battery, said actuator further including a casing with longitudinal axis housing the electric motor, the reduction gear, the battery and at least one part of the control circuit, the charging connector being a standard connector, said actuator being intended to cooperate with a power supply device including a standard connector corresponding to the standard connector of the actuator, the control circuit comprising at least a fixed voltage and one maximum current to the power supply device, said method being implemented by the actuator and comprising at least one step of transmission of a request of a power supply profile comprising at least a fixed voltage and a maximum current, by the control circuit, to the power supply device and a step of supplying power to the at least one battery by means of the power supply device, advantageously according to the requested power supply profile.

In one example of operation, upon establishing an electrical connection between the power supply device and the actuator, the actuator issues a request for a capacity profile of the power supply device prior to the transmission step and, during a selection step, the actuator selects one of a plurality of profiles corresponding to the capacity profile of the power supply device.

In another example of operation, the at least one battery powers an operation of the engine independently of the steps of the power supply method.

In the absence of a request received by the power supply device, a step of delivery of a fixed voltage and of a minimum current to the actuator can be implemented by the power supply device.

### BRIEF DESCRIPTION OF DRAWINGS

The invention will be better understood with the help of the following description and of the appended drawings wherein:

FIG. 1A is a side view of an example of an actuator for driving a sun protection or privacy screen according to the invention,

FIG. 1B is an exploded view of the actuator shown in FIG. 1A,

FIG. 2A is a perspective view of an example of charging connector suitable for the invention,

FIG. 2B is a schematic perspective view of an example of magnetic charging connector,

FIG. 2C is a perspective view of an example of an assembly of a magnetic charging connector and a magnetic connector of the power supply device,

FIG. 3 is a function diagram of the connection between the actuator according to the invention and a power supply device,

FIG. 4 is a flow chart of an example of a method of charging an actuator according to the invention,

FIG. 5 is a detailed view of an actuator head including means for informing the user of the progress of the charging of the battery or of the batteries,

FIG. 6 is a representation of an electrical circuit of the means of information implemented according to an example of the invention,

FIG. 7 is a representation of electrical circuits of the means of information implemented according to another example of embodiment,

FIG. 8 is a front view of an example of a second board that can be implemented in the actuator shown in FIG. 1A,

FIG. 9 is a perspective view of the second board shown in FIG. 8,

FIG. 10 is a top view of a torque support integrating the board shown in FIG. 8,

FIG. 11 is a perspective view of another example of actuator torque support according to the invention,

FIG. 12 is a top view of the torque support shown in FIG. 11.

### DETAILED DESCRIPTION OF EMBODIMENTS

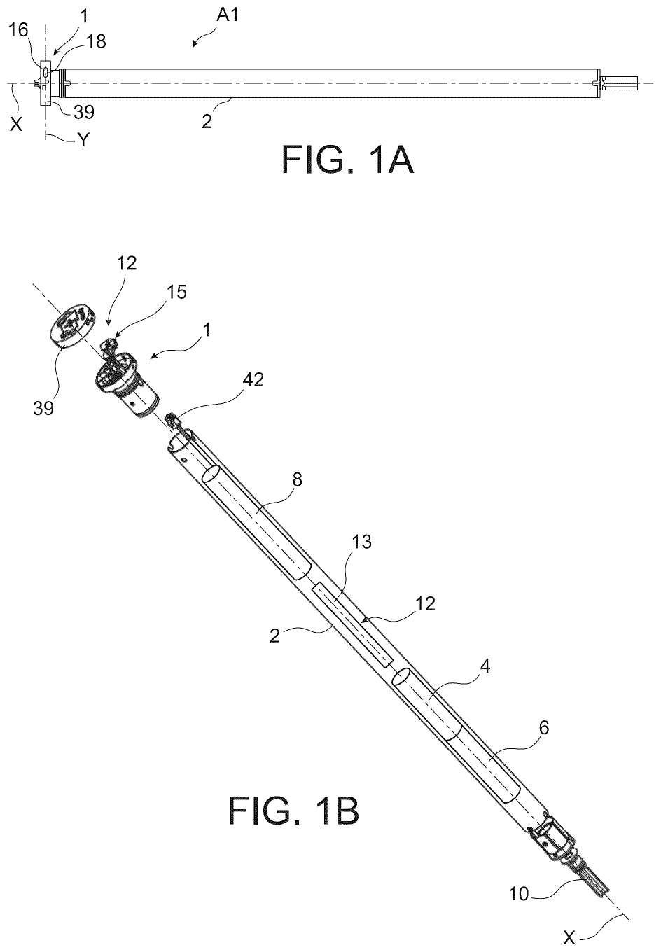

FIGS. 1A and 1B show a schematic representation of an actuator for driving a sun protection or privacy screen (not shown), such as a blind, a shutter or the like, between a plurality of positions.

The actuator A1 has a generally cylindrical shape of revolution of axis X. The actuator A1 includes a torque head or torque support 1, a casing 2 of axis X, an electric motor 4 of axis X, a reduction gear 6, and an electric battery 8. The reduction gear 6 is extended by an output shaft 10 extending along the axis X intended to rotate an element (not shown) belonging to the screen or a winding tube on which the screen is mounted.

The electric battery 8 may be composed of a plurality of electric batteries connected in parallel or in series.

The electric battery is intended to supply to the electric motor with the electric power useful for the rotation thereof.

The actuator further includes a control circuit 12 of the electric motor formed by one or a plurality of circuit boards. The circuit 12 is connected to the motor 4 and to the battery 8. The electric battery is also intended to supply the power to the control circuit 12. The control circuit comprises in particular a first circuit board 13 which, in the example shown, is arranged parallel to the axis X. The control circuit further comprises a second circuit board 15 which, in the example shown in FIGS. 1A and 1B, is located at a longitudinal end of the casing in the torque support 1 and is arranged orthogonally to the axis X.

The control circuit includes an external communication unit for communicating with an external device, in particular a radio frequency wave communication. The communication unit may be supported by one or a plurality of the circuit boards of the control circuit.

The external communication unit comprises in particular a radio frequency transceiver (via which commands to move the screen can be transmitted from a radio remote control (not shown) and physical communication elements for a user, such as a light diode or LED and/or a programming button.

In the example shown, the second circuit board 15 supports a battery charging connector 16. The charging connector 16 allows the actuator to be connected to an external power supply device, such as an external device connected to a mains socket, a photovoltaic panel or an external battery.

The torque support 1 includes a window 18 through which the charging connector is accessible.

According to the invention, the charging connector 16 is a standard connector intended to cooperate with a power supply device 20 (shown diagrammatically) including a standard connector corresponding to the standard connector of the actuator.

In the present application, “standard connector” refers to a connector which is commonly used in other applications, in particular with in preparation for charging batteries, e.g. in electronic and/or computer applications. For example, the connector is a USB (Universal Serial Bus) connector, a connector for transferring audio and video multimedia content in high definition designated HDMI (High Definition Multimedia Interface) cable or a 8-pin Lightning connector developed by Apple.

Furthermore, the control circuit includes means of transmitting, to the power supply device, a request for a power supply profile comprising at least a fixed voltage and a maximum current.

A power supply profile comprises in particular a given voltage value, called a fixed voltage, and a maximum current value. It is of course understood that the voltage of the power supply profile actually supplied by the power supply device can vary substantially with respect to the fixed voltage required, while remaining within the same order of magnitude.

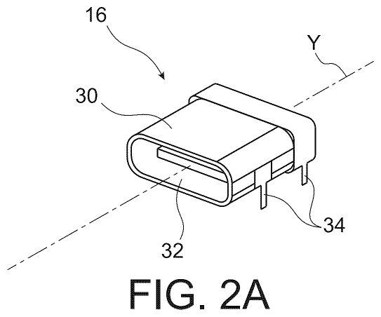

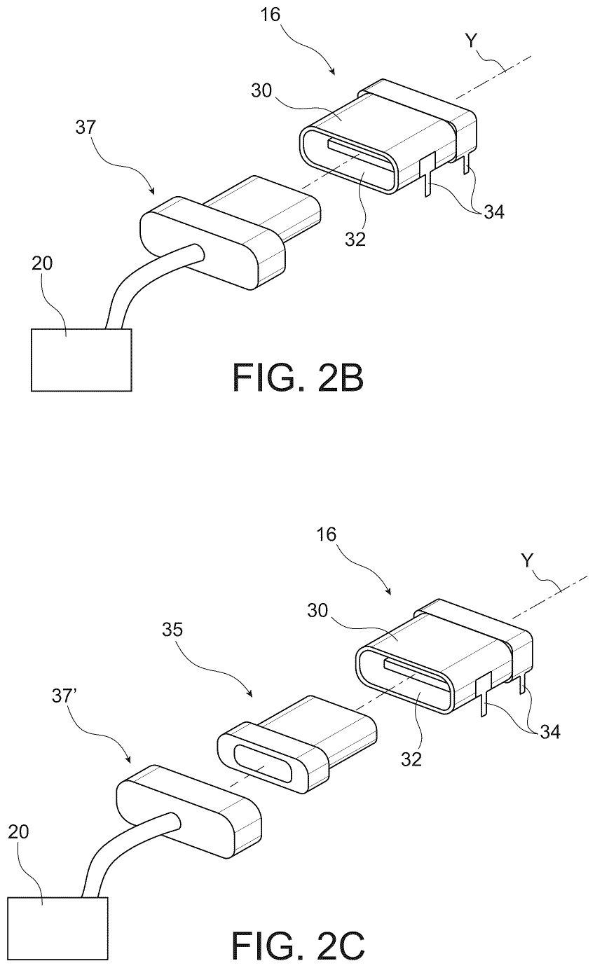

In a particularly advantageous manner, the charging connector 16 is a USB-C® female connector shown alone in FIG. 2A. Such connector has the advantage of having two orthogonal planes of symmetry, is reversible and non-polarized, which allows same to be easily plugged in any direction, which facilitates the connection to the charging source.

The female charging connector includes a body 30 extending along an axis Y and having an oblong cross-section. The connector has an opening end 32 for the insertion of a corresponding male charging connector. The body 30 has fastening lugs 34 extending laterally on both sides of the axis X. The lugs are intended to pass through the board and to be soldered to the opposite face.

The control circuit 12 advantageously includes a controller arranged between the charging connector 16 and the battery or the batteries 8, the controller being configured to charge the battery or the batteries from the voltage and current at the input of the charging connector. The controller makes possible an adaptation of the charge from the profile actually transmitted by the power supply device, indeed as will be described thereafter, a plurality of profiles are possible. The controller is an electronic component, also called a step-down charger for Li-Ion batteries (buck-boost Li-Ion battery charger). For example, in the case of a standard 5V USB connector, the voltage can reach 15V. At 5V, the controller then adapts the charge for the batteries.

The charging connector 16 is intended to cooperate with a compatible charging connector of the power supply device 20 (shown diagrammatically in FIG. 2B). In such example, the power supply device has a male USB-C® connector 37 corresponding to the charging connector 16 of the actuator. An easier connection, e.g. a “blind” connection, is thereby possible, in particular for an actuator that is not very accessible.

In a very advantageous example shown in FIG. 2C, the charging connector of the power supply device 37′ is as such connected to a magnetic adapter 35, which makes possible a facilitated connection, e.g. a “blind” connection, in particular for an actuator that is not very accessible. The connector 37′ of the power supply device 20 is also magnetic, so as to connect to the adapter.

The magnetic interlocking means can be implemented with the different aforementioned standard connectors.

Furthermore, the actuator preferably supports the PD (Power Delivery) technology, and even more preferably the PD technology and the PPS (Programmable Power Supply) technology, associated with the USB version 3.0 and following standards.

The PD technology delivers more power to the battery and charges faster than a connector that is not compatible with PD technology.

The PPS technology provides regularly renegotiated communication between the battery and the power supply, making it possible that the power supply dynamically adjusts voltage and current according to the battery state of charge determined by the actuator. Regularly, all of the parameters change to adapt the needs of the battery, which optimizes the charge thereof and extends the life of the battery.

Since the USB 3.0 PD PPS standard makes it possible to adjust the charging power according to the need of the battery, the result is reduced overheating, longer battery life and optimum charging.

PD and PPS technologies are supported by the actuator and the external power supply.

When connecting the actuator to the power supply, a plurality of exchanges take place consecutively, e.g. 4 or 5.

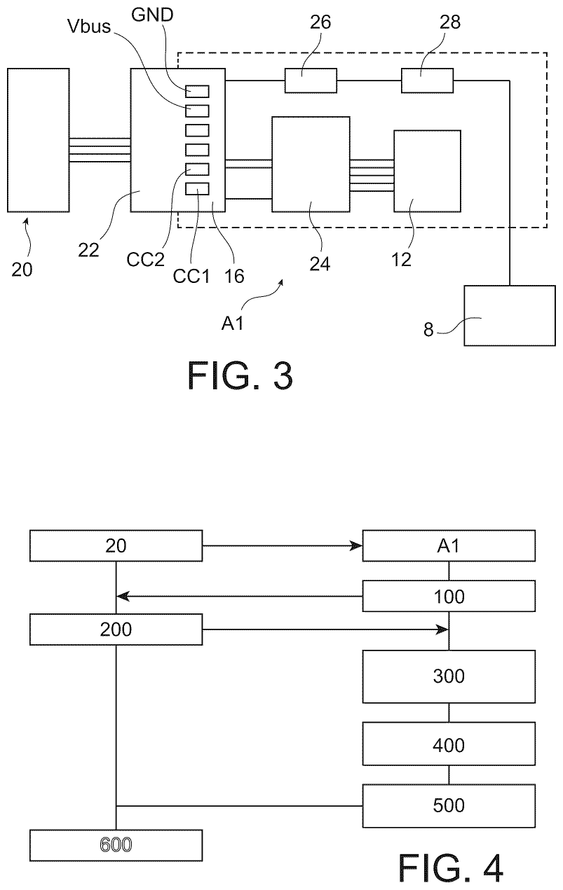

FIG. 3 shows a functional diagram of an example of a power supply device 20 connected to an actuator A1 according to the invention. The part delimited by the broken line represents a part of the control circuit.

The power supply 20 has a male charging connector to connect to the female charging connector 16 of the actuator.

The power supply device 20 includes a control circuit 22 configured to support the PD technology and, if appropriate, the PPS technology.

The charging connector 16 has 16 or 24 pins.

Amongst said pins, GND, Vbus power and CC1 and CC2 data terminals are used.

The VBus pins are used for the actuator power supply. Very advantageously, the same VBUS pins are used regardless of the power supply device, whether it is a device connected to the mains or a photovoltaic panel.

Pins CC1 and CC2 are used for the communication, relating the power supply parameters (voltage, current), between the power supply and the actuator. Very advantageously, the same pins CC1 and CC2 are used for exchanges with a power supply device connected to the mains and with a photovoltaic panel. Other data are also transmitted from the second board to the first board, e.g. additional information on the human-machine interface, which may include e.g. the LED(s), the button(s), the industrial reset protocol, the reset, the readjustment, etc.

Provision can be made for the same pins to be used during a charging phase regardless of the power supply device.

By using the same pins, the number of electrical connections to be made between each of the connectors and the control circuit is limited.

In another embodiment, an Rx pin and a Tx pin are used for the control and configuration of the actuator in the factory or at the installation site. Thereby, the charging connector can be used both for the charge of the battery or of the batteries and for the control and the connector of the actuator.

To this end, through the connections of the charging connector 16, information on linking or pairing and adjustment can be implemented from an adjustment tool such as a personal computer or a specific installation tool, provided with an output port comprising a standard connector compatible with the charging connector of the actuator.

Advantageously, the adjustment tool further comprises means for supplying a charging power supply for the actuator battery and human-machine interface means enabling an installer to input data to be transmitted to the control circuit of the actuator.

Certain pins of the charging connector can thereby be useful for providing the actuator with adjustment data and/or for retrieving, from the actuator, data useful for a diagnostic. The use of the pins for data transmission is independent of the presence or of the absence of a supply current or voltage for charging the battery: the adjustment steps can thus take place simultaneously with a charging step of the battery of the actuator.

In such example of embodiment and in a non-limiting manner, the control circuit 12 shown partially includes an integrated circuit 24 for protecting the charging connector, the circuit protecting against the consequences of a short-circuit. The integrated protection circuit may include TVS (Transient Voltage Suppression) diodes. The integrated protection circuit 24 is interposed between the connector and the control circuit. The control circuit further includes a switch 26 between the charging connector and the battery, the switch 26 is controlled by the integrated protection circuit 24.

The control circuit further includes a power management device 28 interposed between the battery and the switch 26 and controlled by the control circuit.

Very advantageously, a power supply method according to the invention is provided which can also be used in the case where the battery is completely discharged. Such mode is called “dead battery” mode. In such case of discharged battery, the power supply process comprises a step of sending, by the power supply device, a low voltage to initiate communication with the actuator. For example, the minimum voltage for initiating communication is on the order of 5V. More particularly, the sending step follows a predefined period of time following a connection between the actuator and the power supply device, during which, since the actuator is no longer sufficiently charged to require a power supply profile, no information is received by the power supply device.

In such case, the step of sending a minimum voltage enables the actuator to initiate the request transmission step in accordance with the power supply method.

The implementation of the invention also has the advantage of being able to adapt the charging process according to the outside temperature, which serves to optimize the battery life. More particularly, the internal temperature of the actuator is a supplementary parameter that can influence the choice of a profile to be requested. Thereby, the power supply profile requested during the transmission step takes into account the estimated or measured temperature prior to transmission.

An example of how the power supply method is conducted will now be described with reference to FIG. 4.

The actuator is first connected to a power supply via the charging connector 16. Exchanges of information between the actuator and the supply device are then set up.

During a step of requesting capacities 100, the actuator requests the charge capacities thereof from the power supply device. The capacities are different if a power supply connected to the mains or a photovoltaic panel, is involved. Indeed, e.g. the power which can be delivered by the mains power supply device is different from same that can be delivered by the photovoltaic panel. The capacities are also different depending on the technologies with which the power supply is compatible, in particular the PD and/or PPS technologies. In the case of the power supply device that is not compatible with PD or PPS technologies, the voltage and current values that can be transmitted by the power supply device are unique and fixed.

During a step 200, the power supply device responds to the actuator by supplying information on the capacities thereof, during a response step. Alternatively, the power supply device provides an available voltage and current during the response step.

During an optional evaluation step 300, the actuator evaluates the charging needs of the battery, i.e. the power supply parameters suitable for the situation of the battery. Such step takes place when the actuator supports the PPS technology.

During a selection step 400 and in the case where the supply device has supplied information on the capacities thereof, the actuator chooses a charging profile according to the response of the supply device. The charging profile is advantageously selected from a plurality of profiles corresponding to the capacities of the power supply device and, if appropriate, according to the information relating to the evaluated power supply parameters. In one embodiment, the actuator selects from the profiles proposed by the power supply device, the profile that best corresponds to the needs. In another example of embodiment, the actuator further comprises a plurality of current/voltage pairs which can be chosen to best correspond to the capacities of the power supply device.

During a transmission step 500, the actuator informs the power supply device about the selected profile by means of a power supply profile request. During a step 600, the power supply device then sets up the charging process according to the profile selected during a charging step.

In the alternative case where, following the connection between the actuator and the power supply device during step 200, the actuator receives a voltage and a current directly from the power supply device and before the selection step, steps 300 to 600 are omitted and the batteries are charged from the voltage and current available at the input of the charging connector. It can then advantageously be provided to set up a feedback to the user to signal a non-optimal charge, e.g. by means of a particular flashing of the light-emitting diode of the actuator.

The actuator motor can advantageously rotate during the charging phase.

By means of the invention, an interaction is set up between the power supply device and the actuator that serves to make the charge more efficient.

Furthermore, by means of the invention, the type of power supply device can be detected by the actuator due to the exchange of information. The information also allows the behavior of the actuator to be adapted.

Furthermore, the communication between the power supply device and the actuator makes possible a selection of the best power supply profile for battery charging and thus a better management of the charging.

For example, the actuator may provide feedback to the user on the state thereof, e.g. being under charge or charged, by means of indicators, e.g. such as an LED, by moving the screen and/or by transmitting information to a device equipped with a display screen.

In the case of charging by a photovoltaic panel, the charging is interrupted each time a cloud masks the sun. In actuators of the prior art, a feedback is sent each time the charging is stopped and each time the charging is resumed, in particular by means of a brief movement of the screen, which can be considered, by the user, as a malfunction of the actuator.

The invention can make it possible to deactivate the emission of a feedback in the case of a charging by a photovoltaic panel preventing a message to be displayed at each appearance and/or disappearance of the sun. Alternatively, it could be provided only the activation of one a plurality of LEDs and not for the movement of the screen or for the display of a message a screen.

In another example of embodiment, the actuator includes display means MS providing a feedback on the progress of the charging, in particular if the charging takes place in an optimized manner.

In such example, the actuator includes display means MS comprising detection and information means configured to inform the user that the batteries of the actuator are charged according to a first profile and/or the second supply profile.

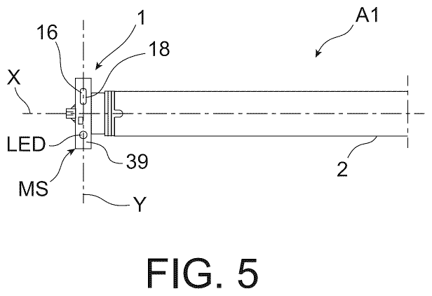

FIG. 5 shows an actuator head with the display means MS, the latter comprising at least one LED.

The user can be the occupant of the building equipped with blinds or blocking elements that charge the actuator or an installer or a person in charge of the installation and/or maintenance of the actuators.

For example, the first power supply profile provides a base voltage and the second power supply profile provides a voltage negotiated at a voltage greater than the base voltage.

In the case of a power supply device that is not compatible with the PD or PPS technologies, the first profile corresponds to the voltage and current values that can be transmitted by the power supply device, which are unique and fixed.

The display means MS include detection means for detecting that the charging of the batteries is taking place at a voltage higher than the base voltage of the supply device, and information means for informing the user when the charging is taking place at a voltage higher than the base voltage of the supply device.

Preferably, the detection means comprise a Zener diode DZ arranged in series with a LED (Light Emitting Diode), hereinafter referred to as LED, intended to inform the user that charging is taking place according to at least one of the first and second power supply profiles. An ohmic protection resistor R is also provided in series. In a variant, the detection means emit a sound signal, or even a sound signal and a light signal.

The detection means are connected in parallel to the power supply connector so as to be supplied by the voltage supplied by the power supply device.

The voltage called Vbus applied by the power supply device applies to the terminals of the display means MS.

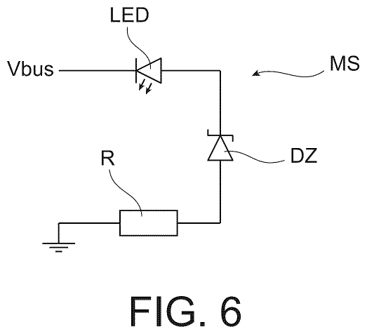

FIG. 6 shows a schematic representation of an electrical circuit of the display means MS.

The Zener diode is arranged upstream of the LED relative to the VBUS pin for connection to the power supply. The threshold voltage of the Zener diode is greater than the base voltage supplied by the power supply device and associated with the first power supply profile, typically 5 volts, and less than the optimum charging voltage, e.g. 15 V, associated with the second power supply profile. The optimal charging voltage has a value on the same order of magnitude as the supply voltage of the motor, i.e. the same order of magnitude as the voltage of the battery or of the batteries together.

The threshold voltage is e.g. equal to 12 V for an optimum voltage value substantially equal to 15 V. The threshold voltage is e.g. equal to 18 V for an optimum voltage substantially equal to 20 V. Thereby, in general, the threshold voltage of the Zener diode is chosen to be lower by a few volts than the optimum threshold voltage.

In the case where the display means MS are carried by the actuator, the Zener diode is advantageously mounted on the second electronic circuit. The overall size is then not increased as a single LED is used, which is particularly advantageous since the space available on the actuator head is generally reduced.

The on/off embodiment: LED off/LED on has the advantage of not having to implement software control to manage the illumination of the LED, only the Zener diode is involved.

In another embodiment, the display means MS comprise, instead of the Zener diode, an electronic circuit comprising a voltage comparator.

The way in which a method of supplying power to the actuator of FIG. 5, comprising the display means MS, takes place is similar to the same shown in FIG. 4 and discussed in detail hereinabove. Steps 100 to 500 are similar.

During step 600, when the selected profile is compatible with a voltage higher than the base voltage of the first power supply profile, the power supply device triggers a supply of the power supply voltage corresponding to the optimum voltage of the second power supply profile. The voltage is higher than the threshold voltage (Zener voltage) of the Zener diode, the result is that the diode becomes conductive and the LED is powered, same illuminates. It is thereby possible to inform the user that the actuator is being charged according to the second power supply profile. The user can infer therefrom that the charging will be relatively fast.

If the power supply device, e.g. a photovoltaic panel, is not able to supply a voltage higher than the threshold voltage, the charging of the actuator continues but the LED does not illuminate and the user is thereby also informed that the charging is not taking place optimally. The user can infer therefrom that the charging will last for a certain time and make arrangements.

In another example of embodiment, the detection means are such that for a voltage lower than the threshold voltage, i.e. the base voltage, the LED flashes and for a voltage higher than the threshold voltage, i.e. the optimum voltage, the LED is illuminated continuously. Such example of embodiment has the advantage of informing that a charging is actually taking place (flashing LED), even if the charging phase is not optimal. However, in order to control the change of state of the LED depending on the supply voltage, a software control is integrated into the second printed circuit, into an additional printed circuit or into a microprocessor on the second board.

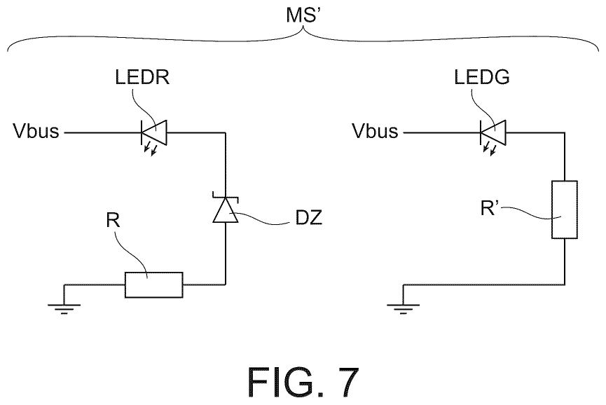

In another example of embodiment, the display means MS' include two light-emitting diodes of different colors, each integrated into a power supply circuit represented schematically in FIG. 7.

One of the light-emitting diodes, e.g. a red light-emitting diode, called LED R, is integrated into a circuit including a Zener diode as already described hereinabove and intended to illuminate for a voltage greater than a threshold voltage. A green LED, called LED G, is integrated into a circuit including only the green LED G and an ohmic resistor R′. The green light emitting diode LED G illuminates as soon as a supply voltage is applied. In such example of embodiment, the user is informed as soon as a charge according to the first power supply profile is applied to the actuator by the illumination of the green light-emitting diode LED G and then that the charge is optimal by the illumination of the red light-emitting diode LED R as soon as the second power supply profile is installed. During an optimum charging, both LEDs are illuminated.

In a variant, both LEDs have the same color and the fact that both LEDs are illuminated informs the user about the optimum charging.

The actuator motor can advantageously rotate during the charging phase.

In another example, it is the power supply device that includes the display means MS. The display means MS can then detect the implementation of the provision of the second power supply profile or when the power supply device changes from the first power supply profile to the second power supply profile, and inform the user thereof.

For example, the MS means are connected in parallel with the connector of the power supply device. Thereby the MS means see the voltage supplied by the power supply to the actuator. All examples of the described display means MS that are integrated into the actuator apply to the power supply device. More particularly, the Zener diode is mounted on a third electronic circuit arranged in the connector of the power supply device and the space requirement is not increased since only one LED is used.

In the example described hereinabove, the voltage is the parameter which varies between the two power supply profiles; in the case where another parameter would be involved, such as the current and/or the time or a plurality of parameters, the display means MS include an electronic circuit suitable for detecting the passage from one profile to the other on the basis of the parameter or the parameters and to transmit a signal.

In another example of embodiment, it is both the actuator and the power supply device that include the display means MS, thereby, depending on the visibility of the actuator and on the power supply device, the user is always informed of the progress of the charging.

In the particular example described, the user is informed when the charging takes place according to the second profile or according to the first profile and then the second profile. Provision could be made for a signal to be transmitted when charging takes place according to the first profile and for the signal to be stopped when charging takes place according to the second profile.

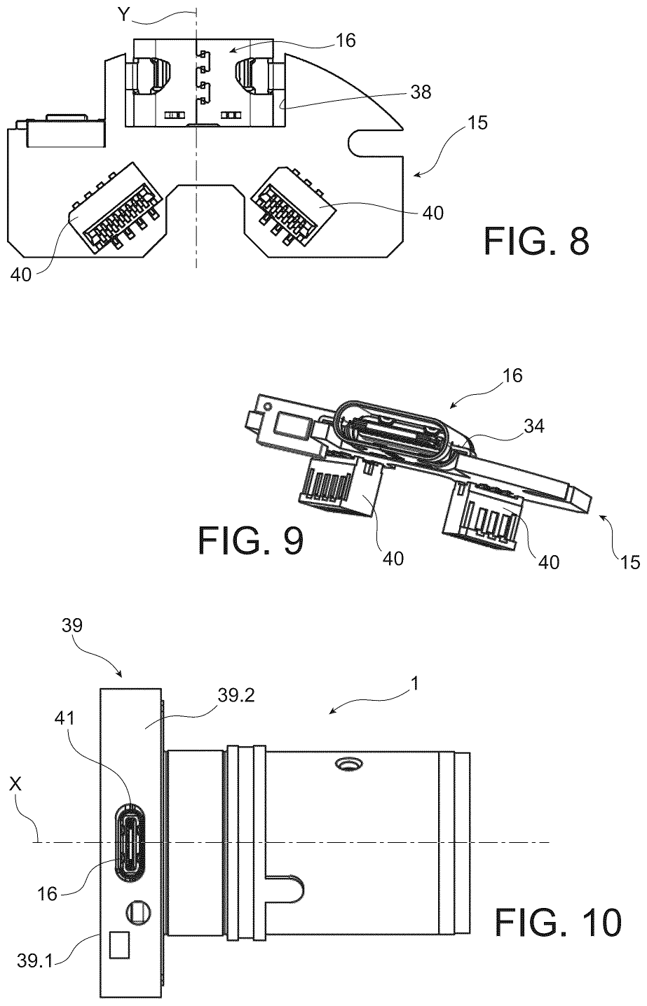

FIGS. 8 to 12 show a very advantageous example of the installation of the charging connector on the second board.

The second circuit board 15 is intended to be arranged at a longitudinal end of the actuator perpendicular to the longitudinal axis X, so that the axis Y of the connector is orthogonal to the axis X. More particularly, the second circuit board is mounted in the torque support 1 of the actuator, at least partly outside the diameter of the casing of the actuator.

The second circuit board 15 is in the form of a printed circuit board having a half-moon general shape configured to fit into the cross-section of the torque support 1.

The charging connector 16 is mounted through the second circuit board 15 which includes a cutout 38 opening out into a rounded edge of the board 15. In such example, the connector is oriented radially so that the open end thereof is oriented outward from the board. The second circuit board 15 has through passages (not visible) for the insertion of fastening lugs 34 which are then folded and/or soldered onto the opposite face of the second circuit board.

In the example shown, the second circuit board 15 includes two connectors 40 on the opposite face thereof which are connected to the connector and are oriented perpendicularly to the plane of the second board, so that the open ends thereof are oriented along the longitudinal axis of the actuator. Such configuration is particularly advantageous because same allows the layer or layers 42 connecting the connector to the first circuit board 13 (FIG. 1A) to be fitted into the connector along the axis of the actuator, without being bent.

Implementing two smaller connectors leads to an easier integration than the implementation of only one large connector. Preferably, the two connectors 40 have a different number of pins, which ensures a foolproof function during assembly.

It should be understood that a second circuit board 15 including only one connector 40 does not depart from the scope of the present invention.

A cover 39 covers the longitudinal end of the torque support. Same has a circular shape provided with a bottom 39.1 and a rim 39.2. A window 41 is made in the rim 39.2 of the cover 39, giving access to the open end of the charging connector (FIG. 10).

This embodiment has the advantage of having a torque support the radial overall size of which is limited.

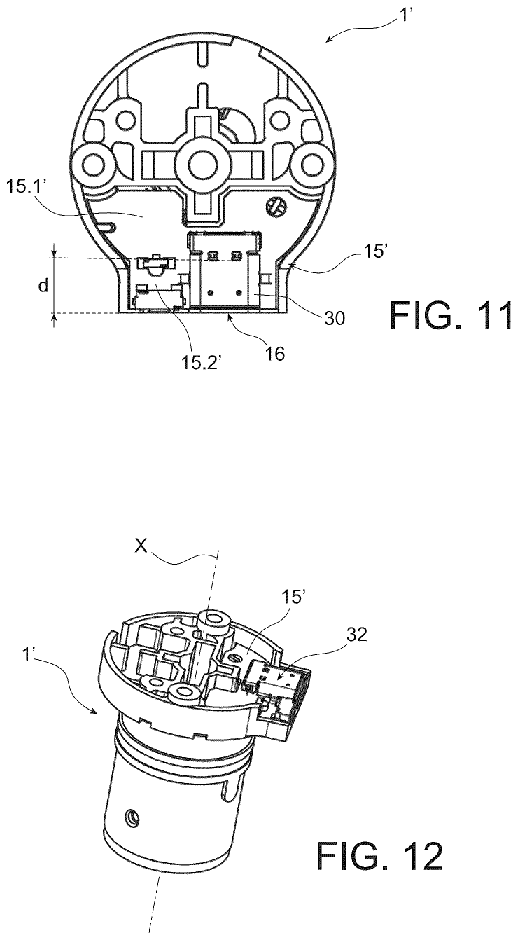

In FIGS. 11 and 12, another example of a second circuit board and another example of a torque support 1′ are shown.

In such example, the second circuit board 15′ comprises a portion 15.1′ in the form of a disk portion corresponding to the general section of the torque support of the actuator and a portion 15.2′ of substantially rectangular shape protruding from the outer periphery of the disk. The dimension D of the part 15.2′ along the radial direction is sufficient for a large part of the body 30 of the charging connector along the radial direction to be located predominantly outside the diameter of the circular section of the casing of the actuator. Such arrangement makes it possible to free the central zone of the second circuit board 15′ in the continuation of the actuator casing and also the central zone of the torque support in order to house, if appropriate, larger electronic components.

Since the central zone of the board 15′ is almost entirely available, it is possible to provide a cutout which can accommodate different shape of force transfer support and thus make the actuator compatible with a large number of support devices for device with sun protection or privacy screen.

The actuator casing has a circular cross-section. The largest diameter part of the torque support may have a transversal cross-section with the shape of a disk, provided with a substantially rectangular protrusion. The cover has a suitable shape. The lateral wall thereof has a window for access to the connector.

The torque support 1′ is shaped to surround the second board 15′ with the protrusion thereof.

In the example shown, the actuator charging connector is a female connector. In a variant, the actuator includes a male charging connector, compatible with a power supply device equipped with a female connector.

An actuator wherein the charging connector is external to the actuator and is connected to the control circuit by a cable does not depart from the scope of the present application.

An actuator wherein the charging connector is arranged so that same is parallel to the X axis or inclined with respect to the X axis does not depart from the scope of the present application.

1. An actuator for driving a sun protection or privacy screen between a plurality of positions of the actuator, the actuator comprising
an electric motor,
a reduction gear,
at least one battery supplying the electric motor,
a control circuit, and
a charging connector configured for the connection of the actuator to a power supply device for supplying power to the at least one battery,
wherein said actuator includes a torque support and a casing with a longitudinal axis housing the electric motor, the reduction gear, the battery and at least one part of the control circuit,
wherein the charging connector is a standard connector,
wherein said actuator is adapted to cooperate with the power supply device including a standard connector corresponding to the charging connector of the actuator, and
wherein the control circuit includes a device for transmitting, to the power supply device, a request of power supply profile comprising at least a fixed voltage and a maximum current.

2. The actuator according to claim 1, wherein the at least one battery comprises a single battery or a plurality of batteries, wherein the control circuit comprises an evaluator for evaluating power supply parameters of the single battery or the plurality of batteries and a device for transmitting information relating to the power supply parameters evaluated through the standard charging connector.

3. The actuator according to claim 1, wherein the charging connector has a plurality of pins and wherein one or more of the plurality of pins is used to transmit the power supply profile required by the actuator.

4. The actuator according to claim 1, wherein the at least one battery comprises a single battery or a plurality of batteries wherein the control circuit comprise a controller arranged between the charging connector and the single battery or the plurality of batteries, the controller being configured to charge the at least one battery based on the voltage and current at the input of the charging connector.

5. The actuator according to claim 1, wherein the control circuit is configured to manage the power supply to the at least one battery in a first mode when the voltage and current at the input of the charging connector correspond to the power supply profile required by the actuator, and in a second mode when the voltage and current at the input of the charging connector differ from the power supply profile required by the actuator.

6. The actuator according to claim 5, wherein the control circuit comprises a user interface and is configured to send at least one item of information through the interface to a user that differs depending on the power supply device connected to the actuator.

7. The actuator according to claim 1, wherein the control circuit comprises a first circuit board supporting a control circuit of the electric motor and a second circuit board supporting the charging connector, the second board being arranged perpendicularly to the longitudinal axis at a longitudinal end of the casing, the charging connector being oriented radially with respect to the longitudinal axis.

8. The actuator according to claim 7, wherein the second board includes a first circular part and a second part radially arranged so as to protrude from the outer contour of the first part, and wherein the charging connector is fixed to the second board so as to extend predominantly at the protrusion.

9. The actuator according to claim 7, wherein the charging connector comprises a plane of symmetry, and the second circuit board includes a cutout wherein the charging connector is mounted, said plane of symmetry being substantially parallel, and substantially coincident, with a plane wherein the second board extends.

10. The actuator according to claim 1, wherein the charging connector complies with the USB-C® standard and is configured to transmit information according to a PD (Power Delivery) technology or according to a PPS (Programmable Power Supply) technology.

11. An assembly including
at least one actuator for driving a sun protection or privacy screen between a plurality of positions of the at least one actuator, comprising
an electric motor,
a reduction gear,
at least one batt electric motor,
a control circuit, and
a standard charging connector, wherein said at least one actuator also includes a torque support and a casing with longitudinal axis housing the electric motor, the reduction gear, the at least one battery and at least one part of the control circuit, and
a power supply device, wherein the standard charging connector is configured for the connection of the actuator to the power supply device for supplying power to the at least one battery,
wherein said actuator is adapted to cooperate with the power supply device,
wherein the control circuit includes a device for transmitting, to the power supply device, a request for a power supply profile comprising at least a fixed voltage and a maximum current,
wherein said power supply device includes at least one standard connector compatible with the standard charging connector of the actuator and wherein, when the power supply device is connected to the actuator and upon reception of the request for the power supply profile comprising at least the fixed voltage and the maximum current, the power supply profile is selected by the actuator according to the capacities provided by the power supply device, the power supply device being configured to supply the voltage and current corresponding to the profile.

12. The assembly according to claim 11, wherein the actuator and the charging connector thereof are configured to support a power delivery technology according to at least a first power supply profile and a second power supply profile during a charging phase, the first power supply profile and the second power supply profile being distinct by at least one power supply profile parameter value, such that the power supply device delivers voltage and current according to the first power supply profile and the second power supply profile, and wherein the actuator and/or the power supply device include a display device configured to inform a user that a charging phase of the battery, by the power supply device, progresses according to at least one amongst the first and the second power supply profile.

13. The assembly according to claim 11, wherein, during the charging phase, the assembly is configured so that the actuator is powered by the power supply device, successively according to the first power supply profile and according to the second power supply profile.

14. The assembly according to claim 12, wherein the display device is connected in parallel with the actuator charging connector or in parallel with the connector of the power supply device.

15. The assembly according to one of claim 12, wherein the display device include at least one first electrical circuit comprising at least one first indicator light, the first indicator light comprising a light-emitting diode (LED), wherein the first indicator light illuminates when the charging phase takes place according to at least one of the first and second power supply profiles.

16. The assembly according to claim 15, wherein the first electrical circuit includes at least one Zener diode in series with the LED, and wherein the threshold voltage of the Zener diode is greater than a voltage value associated with the first power supply profile.

17. The assembly according to claim 15, wherein the first indicator light illuminates when the charging phase progresses according to the second power supply profile and stays off when the charging phase progresses according to the first power supply profile.

18. The assembly according to claim 15, wherein the display device includes a second electrical circuit comprising a second indicator light and an ohmic resistor in series, the first and second electrical circuits being connected so that the second indicator light illuminates as soon as the actuator is powered according to the first power supply profile by the power supply device and the first indicator light illuminates when the charging phase takes place according to the second power supply profile.

19. The assembly according to claim 15, wherein the display means is configured such that the first indicator flashes upon delivery of voltage by the power supply device according to the first power supply profile and the first indicator stays illuminated steadily upon supply of power to the actuator according to the second power supply profile.

20. The assembly according to claim 11, wherein the charging connector and the power supply device comprise magnetic interlocking means.

21. A method of supplying power to an actuator for driving a sun protection or privacy screen between a plurality of positions, the actuator including an electric motor, a reduction gear, at least one battery powering the electric motor, a control circuit, a charging connector configured to enable the actuator to be connected to a device for supplying power to the at least one battery, said actuator further including a casing with longitudinal axis housing the electric motor, the reduction gear, the battery and at least one part of the control circuit, the charging connector being a standard connector, said actuator being adapted to cooperate with a power supply device including a standard connector corresponding to the charging connector of the actuator, the control circuit comprising at least a fixed voltage and one maximum current to be received from the power supply device, said method being implemented by the actuator and comprising at least one step of transmission of a request of a power supply profile comprising at least the fixed voltage and the one maximum current, by the control circuit, to the power supply device and a step of supplying power to the at least one battery by means of the power supply device according to the requested power supply profile.

22. The power supply method according to claim 21, wherein, upon establishing an electrical connection between the power supply and the actuator, the actuator issues a request for a capacity profile of the power supply prior to the transmission step and, during a selection step, the actuator selects one of a plurality of power supply profiles corresponding to the capacity profile of the power supply device.

23. A power supply method according to claim 21 wherein the at least one battery supplies power to the operation of the motor independently of the steps of the power supply method.

24. The power supply method according to claim 21, wherein in the absence of the request of the power supply profile received by the power supply device, further comprising a step of delivery of the fixed voltage and of a minimum current to the actuator is implemented by the power supply device.
